(19) United States
(12) Patent Application Publication
(10) Pub. No.: US 2012/0154342 A1
(43) Pub. Date: Jun. 21, 2012

(54) DRIVING CIRCUIT FOR LCOS ELEMENT

(76) Inventor: Yuji Hotta, Aichi (JP)

(21) Appl. No.: 13/023,645

(22) Filed: Feb. 9, 2011

(30) Foreign Application Priority Data
Dec. 21, 2010 (JP) 2010-284169

(51) Int. Cl. G09G 5/00

(52) U.S. Cl. 345/204

(57) ABSTRACT

The LCOS element driving circuit is provided with a plurality of D/A converters for effecting D/A conversion on pixel data which is fed to each pixel of a LCOS element on a pixel group-by-pixel group basis and delay devices for delaying clock signals to provide timing for each D/A conversion operation. The clocks to be fed to the respective D/A converters are delayed via the delay devices to cause variation in delay time, so that output pixel signals from the D/A converters can be applied to the LCOS element in a synchronized state. This makes it possible to drive the LCOS element at high speed.

### BACKGROUND OF THE INVENTION

1. Field of the Invention

The present invention relates to a driving circuit designed for an LCOS (Liquid Crystal On Silicon)-type liquid crystal element for use in the field of optical communications and so forth.

2. Discussion of the Related Art

Optically variable filters have currently been in wide use in such fields as typified by optical communications and spectrometry. Particularly in the field of optical communications, in keeping up with the recent demand for great transmission capacity, active research and development have been conducted on an increase in transmission rate and novel modulation formats, and also optical networks have come to become more and more complex. In such an optical network, an optically variable filter capable of causing variation of light with desired wavelength out of optical signals is used. For example, in US 2006/0067611 A1, there is disclosed an optically variable filter apparatus that employs, as a wavelength selection element, a two-dimensional reflection-type liquid crystal LCOS (Liquid Crystal On Silicon) element (hereafter referred to simply as “LCOS element”).

As presented for example in Japanese Laid-open Patent Publication 2007-072403 and Japanese Laid-open Patent Publication 2008-65209, the LCOS element has originally been developed for image-display purposes. Therefore driver ICs designed specifically for the LCOS element are commercially available for image-display applications. The use of such a purpose-built driver allows easy display of images on the LCOS element.

In the field of optical communications, an optically variable filter apparatuses are required to have the capability of center-frequency control in a filter at the level of optical frequency and variation with respect to transmission rates of optical signals and modulation formats for the attainment of an optimal passband. However, in a case where the LCOS element is used as a filter for optical-communication applications to change filter characteristics at high speed, the light reflection states or light transmission states of a plurality of pixels of the LCOS element need to be varied at the same time at high speed. In the method of driving the LCOS element at higher speed than would be the case where it is used for image-display applications, the use of a purpose-built driver IC without any alteration may be difficult.

Especially in a case where a voltage to be applied to each pixel is converted into an analog signal by a high-resolution D/A converter before application, if the resolution of the D/A converter is as high as for example 12 or above in bit, existing purpose-built driver ICs will no longer be usable. In view of the foregoing a new-type driving circuit including a D/A converter needs to be constructed. However, in the presence of great variation in length among constituent components including the D/A converter and signal lines, the timing of application of pixel signals to individual pixels is caused to vary, which results in limitations to the rate of change in filtering. Thus, from the standpoint of both speed and resolution, it is difficult to use a commercially available purpose-built driver IC without any alteration.

### SUMMARY OF THE INVENTION

The present invention has been devised in view of the problems associated with conventional art as mentioned supra, and accordingly its object is to provide a driving circuit for an LCOS element that is capable of driving the LCOS element at high speed and is thus suitable for use in optical communications.

An LCOS element driving circuit for driving an LCOS element of the present invention having pixels arranged in a two-dimensional lattice pattern by application of voltage to pixel groups, each consisting of a plurality of pixels, on a pixel-by-pixel basis, comprises: a plurality of D/A converters which effect D/A conversion on a plurality of pieces of pixel data on a pixel group-by-pixel group basis; a first delay device which delays a clock signal fed to said LCOS element; and a plurality of second delay devices which delay clock signals fed to said D/A converters, respectively, wherein a delay time of said first delay device and delay times of said second delay devices are so determined as to ensure synchronization between the clock signal to be fed to said LCOS element and D/A-converted outputs from said D/A converters.

In the LCOS element driving circuit, said first and second delay devices may be each of a clock phase adjuster incorporated in FPGA.

According to the present invention having such a feature, in the case of driving the LCOS element by an independently-provided driving circuit constructed of separate D/A converters using a high-speed clock, it is possible to ensure synchronization between a clock signal and a pixel signal. Accordingly the LCOS element can be driven at high speed and with high resolution even in optical-communication applications and so forth. This makes it possible to achieve changes in a passband width and in the center frequency of a passband as well at high speed with use of the LCOS element.

### BRIEF DESCRIPTION OF THE DRAWINGS

FIG. 1 is a circuit diagram showing an LCOS element and a driving circuit therefor in accordance with an embodiment of the present invention;

FIG. 2 is a diagram showing the internal configuration of the LCOS element;

FIG. 3 is a block diagram showing the configuration of the driving circuit in accordance with the embodiment of the present invention;

FIG. 4 is a circuit diagram showing a comparative example of the driving circuit;

FIG. 5 is a diagram showing a time relation in the driving circuit of the comparative example;

FIG. 6 is a diagram showing an example of the operation and time relation in the driving circuit of the embodiment; and

FIG. 7 is a time chart showing the operation of the LCOS element which employs the driving circuit of the embodiment.

### DESCRIPTION OF THE PREFERRED EMBODIMENTS

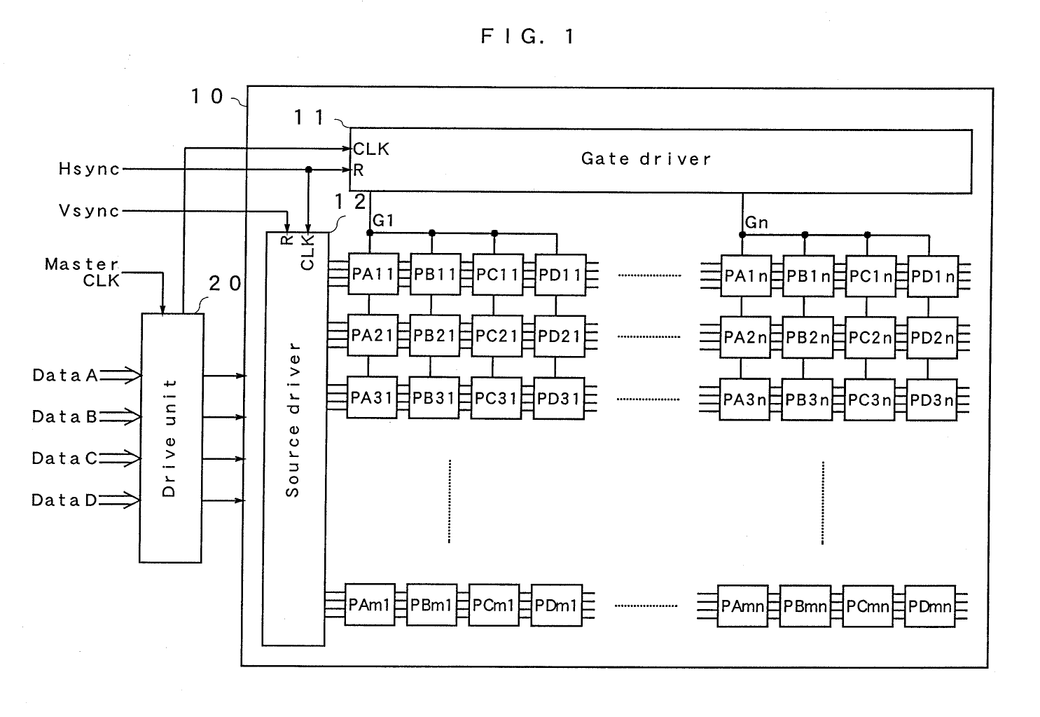

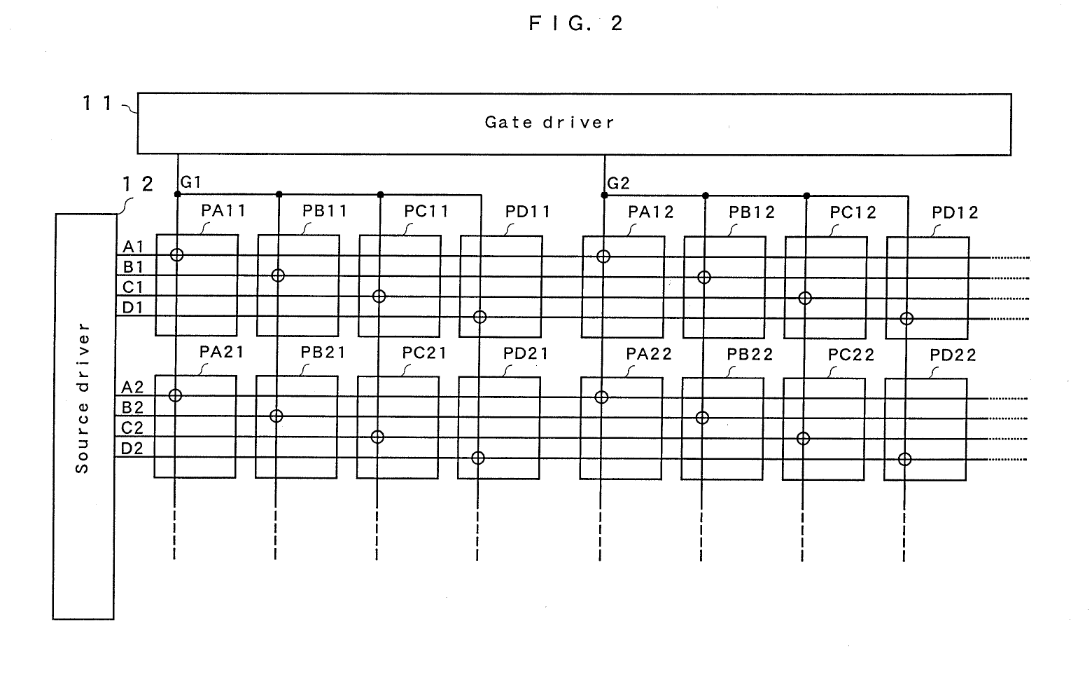

FIG. 1 is a diagram showing an LCOS element and a driving circuit therefor in accordance with a first embodiment of the present invention, and FIG. 2 is a diagram showing the internal configuration of the LCOS element. In the present embodiment, that the LCOS element 10 is used as an optical filter for optical communications. As shown in FIG. 1, the LCOS element 10 is composed of a lattice arrangement of pixel groups. Each of the pixel groups is a unit consisting of a plurality of, in this construction, four pieces of pixels: PAij, PBij, PCij, and PDij (i is a value in a 1 to m range, j is a value in a 1 to n range), namely groups of pixels ranging from PA11 to PDmn. For example, m is set at 1080 and n is set at 480. A voltage adapted to desired filter characteristics is applied to the pixel group consisting of four pixels on a pixel-by-pixel basis. At this time, the four pixels constituting the pixel group need to be driven concurrently. The LCOS element 10 receives input of a clock signal, a horizontal synchronization signal H_{sync}, and a vertical synchronization signal V_{sync}. The LCOS element 10 is provided with a gate driver 11 for feeding gate signals G1 to Gn thereto on a pixel group-by-pixel group basis. The gate driver 11 receives input of a clock signal as a shift pulse and input of a horizontal synchronization signal H_{sync} as a reset pulse. Moreover, the LCOS element 10 is provided with a source driver 12 aligned with a vertical direction. The source driver 12 receives input of a horizontal synchronization signal H_{sync} as a shift pulse and input of a vertical synchronization signal V_{sync} as a reset signal. The source driver 12 acts to produce output of source signals Ai, Bi, Ci, and Di taken as a group, namely source signal groups ranging from a group of A1 to D1 to a group of Am to Dm one after another. A drive unit 20 receives input of four pieces of data, namely data A to data D indicative of the levels of voltages to be impressed on the four pixels of each pixel group. The drive unit is a driving circuit whereby each data is D/A-converted and the converted output is fed to the LCOS element 10.

Next, the internal configuration of the LCOS element 10 will be described with reference to FIG. 2. The gate driver 11 of the LCOS element 10 has an n-bit shift resistor. The gate driver 11 puts out gate signals G1 to Gn one after another in response to a clock signal in a repetitive manner. The gate signal G1 is fed to the pixel groups ranging from the group of PA11 to PD11 to the group of PAm1 to PDm1, and the gate signal G2 is fed to the pixel groups ranging from the group of PA21 to PD21 to the group of PAm2 to PDm2. Likewise, the subsequent gate signals are successively put out to n pieces of their respective pixel groups. Pixel signals A1, B1, C1, and D1 are put out from the source driver 12 to the pixels PA11 to PD11 so as to be timed to the output of the gate signal G1. Subsequently the pixel signals A1, B1, C1, and D1 are put out concurrently from the source driver 12 to the pixels PA12 to PD12 so as to be timed to the output of the next gate signal, namely the gate signal G2. From then on, the output operation is continued in a like manner until the pixels PA1n to PD1n receive pixel signals. In the scanning of the next line, similarly, the gate signals G1, G2, and so on are put out, and the pixel signals A2 to D2 are put out in timed relation therewith. A circular symbol lying at a point of intersection of a gate signal line and a source signal line on each pixel represents a switching element. The switching element is turned ON so as to be timed to the coincidence of signals at the intersection to bring the pixel into an ON state. When the ON state is established, a pixel signal is applied to the non-illustrated electrode of the pixel. The reflectivity or transmittance of the pixel is determined in accordance with the voltage of the applied pixel signal.

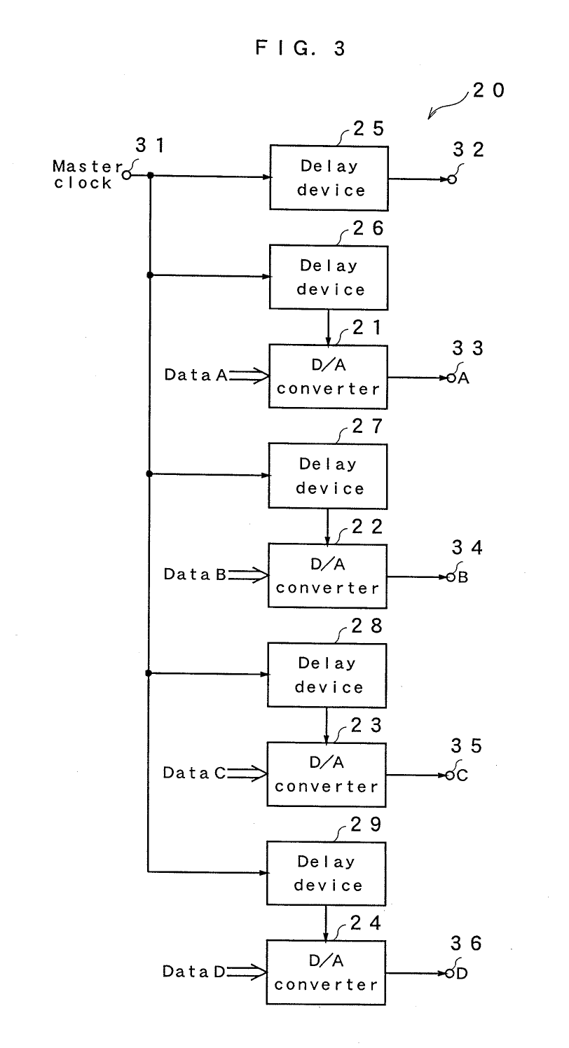

Next, the configuration of the drive unit 20 will be described with reference to FIG. 3. The drive unit 20 has D/A converters 21 to 24 and delay devices 25 to 29. Data A, data B, data C, and data D, which are four digital signals, are fed to the D/A converters 21 to 24, respectively. Moreover, a clock signal serving as a master clock is fed to an input terminal 31 of the drive unit 20. The master clock is fed, through the first delay device 25, to an output terminal 32, and from there put out to the LCOS element 10 as a clock signal. Also, the master clock is fed, as a clock signal, to the D/A converters 21 to 24, respectively, through the second delay devices 26, 27, 28, and 29, respectively. The D/A converters 21 to 24 effect D/A conversion on the digital data A, B, C, and D, respectively, so as to be timed to the provision of the clock signals, and the resultant analog pixel signals A, B, C, and D are put out to the source driver 12 of the LCOS element 10 through output terminals 33 to 36.

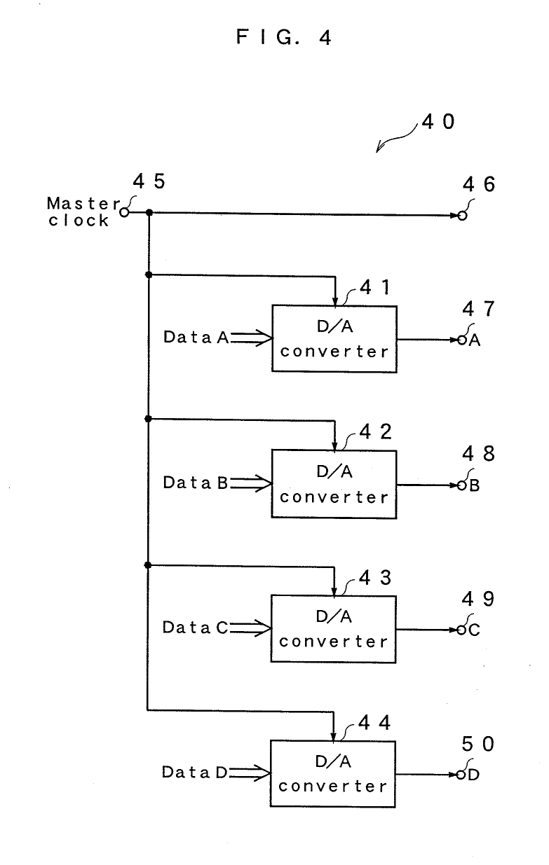

The delay devices 25 to 29 may be constructed either of a purpose-built delay element or of FPGA (Field Programmable Gate Array). The delay devices 25 to 29 are each configured for external setting of delay time. FIG. 4 is a block diagram showing a comparative example of the drive unit. This drive unit 40 has four D/A converters 41 to 44. A master clock is fed to an input terminal 45, and it is put out from an output terminal 46 in an as-is state. The D/A converters 41 to 44 effect D/A conversion on four pieces of digital data A, B, C, and D, respectively, in response to the master clock signal, and the resultant pixel signals A, B, C, and D in analog form are put out from output terminals 47 to 50, respectively.

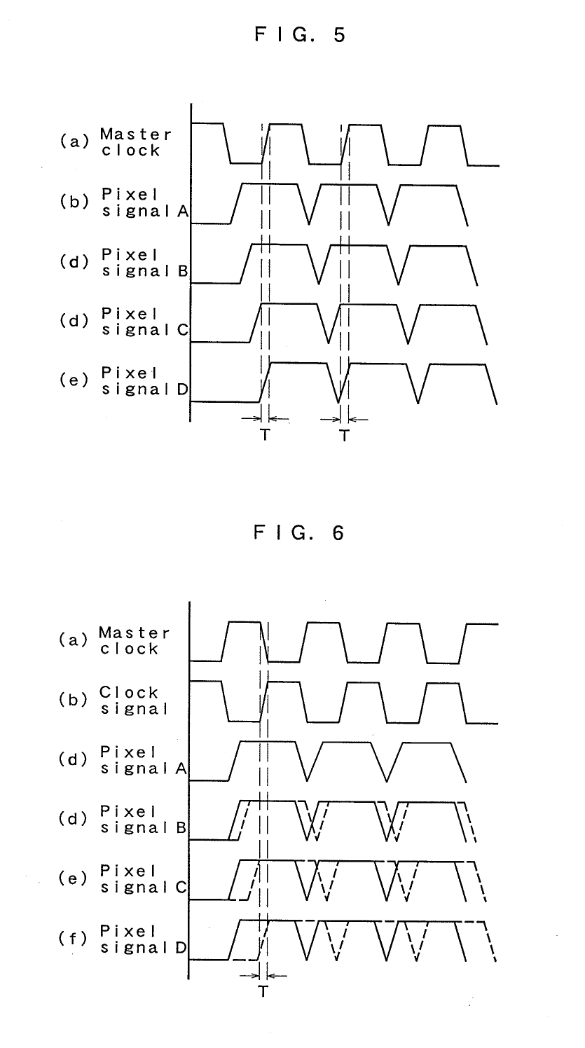

Firstly the operation of the comparative example will be described with reference to the time chart shown in FIG. 5. In FIG. 5(a), there is shown a master clock signal to be fed to the input terminal 45. In FIG. 5, (b) to (e) show analog pixel signals A to D put out from the output terminals 47 to 50, respectively. As shown in the figures, an analog signal obtained through D/A conversion is put out correspondingly with one clock-signal period. So long as the clock signal and the analog pixel signals from the output terminals 47 to 50 are perfectly synchronized with each other, even with an increase in clock frequency, there arises no problem. However, in the circuitry in actuality, the clock signal and the analog signal become out of synchronization each other with regard to time due to a mismatch in wiring length or impedance, variation in IC output, and so forth. For example, as shown in FIG. 4, the line length from the clock-signal input terminal 45 to the clock input terminal of the D/A converter 41, that to the D/A converter 42, that to the D/A converter 43, and that to the D/A converter 44 differ from one another on the circuit board. Therefore, as the clock frequency is increased, correspondingly the timing of input of the sampling clock is slightly varied according to the line lengths. As a result, as shown in FIG. 5, the pixel signals are put out at slightly different timings with respect to the timing of input of the clock.

In the LCOS element 10, four analog pixel signals A to D are sampled to be fed to each pixel of the LCOS element during a sampling time T at a rise of the clock signal. Accordingly, as shown in FIG. 5(e), if the pixel signals do not stand in a stable level during the sampling time T at the rise, a signal of an unexpected level will be fed to each pixel, with consequent occurrence of malfunction.

In view of the foregoing, in the driving circuit of this embodiment, as shown in FIG. 3, the delay devices 25 and 26 to 29 are used to achieve coincidence on time axis between a clock signal and analog outputs. In the timing adjustment operation, a delay time set for each of the delay devices 26 to 29 is so determined that coincidence on time axis can be achieved between an output clock and each of the pixel signals A to D. For example, in the case of using a purpose-built delay element for each delay device, delay-time adjustment is made to each of the delay elements on an individual basis. On the other hand, in the case of using FPGA (Field Programmable Gate Array) therefor, delay-time adjustment is made by writing data into a built-in clock phase adjuster.

At this time, given that the delay time of each delay device is indicated in terms of phase, delay devices adapted for phase adjustment within a range of 360 degrees with respect to a master clock are used as the delay devices 25 to 29, and the delay devices 25 to 29 are each temporarily configured for a 180 degree phase shift. In this way, the clock signal put out from the output terminal 32 as shown in FIG. 6(b) is reversed in phase to the input master clock as shown in FIG. 6(a). In order to keep the pixel signals put out respectively from the D/A converters 21 to 24 in a stable level during the sampling time T at the rise of the clock signal, phase control is exercised by making delay-time adjustment in such a manner that, for example, the timing of the pixel signal can be changed from a state indicated by a broken line to a state indicated by a solid line as shown in FIGS. 6(d) to 6(f). In this way, by ensuring synchronization between a clock signal and each analog output in advance, it is possible to feed the desired pixel signals A to D synchronized with the clock signal in a stable condition to the four-pixel groups of the LCOS element 10 concurrently at a proper timing. It is noted that the delay device 25 may be used to exercise overall control, for example, used to change the delay time of the clock signal following the completion of adjustment to the other delay devices 26 to 29.

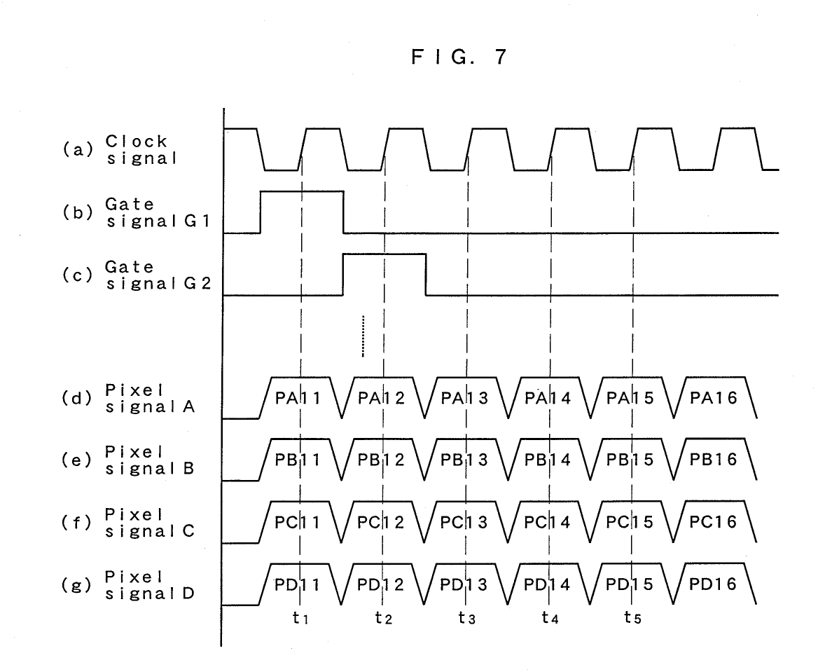

FIG. 7 is a time chart showing a clock, gate pulses, and pixel signals that are fed to the LCOS element following the completion of such a timing adjustment. As shown in FIGS. 7(a) to 7(c), with the clock signal serving as a shift pulse, gate signals G1, G2, and so on are put out from the gate driver 11. Simultaneously pixel signals A1 to D1 are put out from the source driver 12. When the gate signal G1 is provided at a timing of H level, then the pixel signal A1, the pixel signal B1, the pixel signal C1, and the pixel signal D1 are to be fed to the pixel PA11, the pixel PB11, the pixel PC11, and the pixel PD11, respectively. These signals are sampled to be fed to their respective pixels concurrently at the time t₁. When the gate signal G2 is provided at a timing of H level, then the pixel signal A1, the pixel signal B1, the pixel signal C1, and the pixel signal D1 are to be fed to the pixel PA12, the pixel PB12, the pixel PC12, and the pixel PD12, respectively. These signals are sampled to be fed to their respective pixels concurrently at the time t₂. Likewise, the gate signal Gn is provided for the feeding of the corresponding pixel signals and thereupon the scanning of the end of the first array is completed. Then, the source driver 12 produces output of pixel signals A2, B2, C2, and D2 for the next array in the same manner. In this way, each and every pixel is subjected to scanning. As shown in FIG. 7, since coincidence on time axis is achieved between the clock and each pixel signal, it is possible to eliminate variation in voltage even with an increase in clock rate, and thus use the LCOS element as a filter by virtue of high resolution capability.

As particularized heretofore, according to the present invention, even in the case where a driving circuit for driving a LCOS element with a high-speed clock is constructed of separate D/A converters, analog signals on the output side can be brought into coincidence on time axis with each other. Accordingly, an LCOS element which employs this driving circuit is able to find applications in high-speed optical communications. Moreover, the present invention is applicable not only to the field of optical communications but also to the field of spectrometry.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese application No. 2010-284169 filed on Dec. 21, 2010 is hereby incorporated by reference.

What is claimed is:

1. An LCOS element driving circuit for driving an LCOS element having pixels arranged in a two-dimensional lattice pattern by application of voltage to pixel groups, each consisting of a plurality of pixels, on a pixel-by-pixel basis, comprising:
a plurality of D/A converters which effect D/A conversion on a plurality of pieces of pixel data on a pixel group-by-pixel group basis;
a first delay device which delays a clock signal fed to said LCOS element; and
a plurality of second delay devices which delay clock signals fed to said D/A converters, respectively,
wherein a delay time of said first delay device and delay times of said second delay devices are so determined as to ensure synchronization between the clock signal to be fed to said LCOS element and D/A-converted outputs from said D/A converters.

2. The LCOS element driving circuit according to claim 1, wherein
said first and second delay devices are each of a clock phase adjuster incorporated in FPGA.
